(19) United States
(12) Patent Application Publication
(10) Pub. No.: US 2026/0356379 A1
(43) Pub. Date: Nov. 12, 2026

(54) IN-VEHICLE DEVICE, PROGRAM, AND INFORMATION PROCESSING METHOD

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Genta YAMANE, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/475,221

(22) PCT Filed: Feb. 28, 2024
(86) PCT No.: PCT/JP2024/007395

§ 371 Date: Oct. 14, 2025

(30) Foreign Application Priority Data
Apr. 18, 2023 (JP) 2023-067872

(51) Int. Cl. B60W 50/023; G05D 1/87

(52) U.S. Cl. CPC B60W 50/023; G05D 1/87

(57) ABSTRACT

An in-vehicle device is mounted in a vehicle and is communicably connected to a plurality of in-vehicle ECUs, and includes a control unit configured to perform processing related to state management of the in-vehicle ECUs. The control unit acquires state data related to states of the in-vehicle ECUs from the in-vehicle ECUs. If it is determined based on the acquired state data that an in-vehicle ECU is not operating normally, the control unit specifies a redundant ECU to substitute for the in-vehicle ECU determined not to be operating normally. The control unit performs processing for causing the redundant ECU to substitute for the in-vehicle ECU determined not to be operating normally.

### CROSS-REFERENCE TO RELATED APPLICATIONS

This application is the U.S. national stage of PCT/JP2024/007395 filed on Feb. 28, 2024, which claims priority of Japanese Patent Application No. JP 2023-067872 filed on Apr. 18, 2023, the contents of which are incorporated herein.

### TECHNICAL FIELD

The present disclosure relates to an in-vehicle device, a program, and an information processing method.

### BACKGROUND

A vehicle is equipped with a body ECU, which is an in-vehicle ECU that performs overall control of body-related devices such as a wiper drive device, interior and exterior lighting devices, door lock devices, and power windows (e.g., JP 2017-224926A). The wiper drive device of JP 2017-224926A includes an in-vehicle ECU (body ECU), and is driven by a control program applied to the in-vehicle electronic control unit (ECU).

The in-vehicle ECU mounted in the vehicle of JP 2017-224926A does not take into consideration performing processing related to substituting for another in-vehicle ECU when the other in-vehicle ECU fails or stops operating normally.

The present disclosure aims to provide an in-vehicle device and the like that can efficiently perform processing related to substituting for an in-vehicle ECU when any of the in-vehicle ECUs mounted in a vehicle stops operating normally.

### SUMMARY

An in-vehicle device according to an aspect of the present disclosure is an in-vehicle device that is mounted in a vehicle and is communicably connected to a plurality of in-vehicle ECUs, including a control unit configured to perform processing related to state management of the in-vehicle ECUs, in which the control unit acquires state data related to states of the in-vehicle ECUs from the in-vehicle ECUs, if it is determined based on the acquired state data that an in-vehicle ECU of the in-vehicle ECUs is not operating normally, the control unit specifies a redundant ECU to substitute for the in-vehicle ECU determined not to be operating normally, and the control unit performs processing for causing the redundant ECU to substitute for the in-vehicle ECU determined not to be operating normally.

### ADVANTAGEOUS EFFECTS

According to one aspect of the present disclosure, it is possible to provide an in-vehicle device and the like that efficiently perform processing related to substituting for an in-vehicle ECU mounted in a vehicle when the in-vehicle ECU stops operating normally.

### BRIEF DESCRIPTION OF DRAWINGS

FIG. 1 is a schematic diagram illustrating a system configuration of an in-vehicle system according to a first embodiment.

FIG. 2 is a block diagram illustrating an example of an internal configuration of an in-vehicle device (integrated ECU).

FIG. 3 is an explanatory diagram illustrating an ECU state table.

FIG. 4 is an explanatory diagram illustrating an example of a substitution table.

FIG. 5 is an explanatory diagram illustrating an example of a relay table.

FIG. 6 is an explanatory diagram illustrating a flow (sequence) of processing performed by an in-vehicle device, a redundant ECU, and the like.

FIG. 7 is a flowchart illustrating processing performed by a control unit of the in-vehicle device.

FIG. 8 is a flowchart illustrating processing performed by a control unit of an in-vehicle device according to a second embodiment (specified based on a processing load).

FIG. 9 is a flowchart illustrating processing performed by a control unit of an in-vehicle device according to a third embodiment (specified based on a substitution capacity).

FIG. 10 is a schematic diagram illustrating a system configuration of an in-vehicle system according to a fourth embodiment (an integrated ECU includes a redundant ECU).

### DETAILED DESCRIPTION OF PREFERRED EMBODIMENTS

First, embodiments of the present disclosure will be listed and described. In addition, at least some of the embodiments described below may be combined in any manner.

An in-vehicle device according to an aspect of the present disclosure is An in-vehicle device that is mounted in a vehicle and is communicably connected to a plurality of in-vehicle ECUs, including a control unit configured to perform processing related to state management of the in-vehicle ECUs, in which the control unit acquires state data related to states of the in-vehicle ECUs from the in-vehicle ECUs, if it is determined based on the acquired state data that an in-vehicle ECU of the in-vehicle ECUs is not operating normally, the control unit specifies a redundant ECU to substitute for the in-vehicle ECU determined not to be operating normally, and the control unit performs processing for causing the redundant ECU to substitute for the in-vehicle ECU determined not to be operating normally.

In this aspect, the in-vehicle device is communicably connected to the plurality of in-vehicle ECUs via the in-vehicle network mounted in the vehicle. These plurality of in-vehicle ECUs perform processing for executing various services or functions provided in the vehicle. The in-vehicle ECU may include not only an in-vehicle ECU that is mounted during production of the vehicle, but also an in-vehicle ECU (backup ECU) that is attached (retrofitted) after production of the vehicle. The backup ECU may, for example, acquire messages output from the in-vehicle ECU (sensor/actuator control ECU) to which a sensor, an actuator, and the like are directly connected via signal lines and the like, and use the acquired messages to perform processing for executing various services or functions. The control unit of the in-vehicle device may aggregate information (state information) on the states of the in-vehicle ECUs, including the backup ECU, the sensor/actuator control ECU, and the redundant ECU, that is, information on whether the in-vehicle ECUs are in an operating state (wake-up state) or a stopped state (sleep state), and perform processing related to management of the current state of the in-vehicle ECUs. The state information of the in-vehicle ECUs may include management information related to the function provided by the respective in-vehicle ECUs and whether or not each in-vehicle ECU is operating normally (normal or abnormal). Furthermore, the control unit of the in-vehicle device periodically, regularly, or constantly performs polling communication and the like with these in-vehicle ECUs to acquire state data related to the states of the in-vehicle ECUs. The control unit of the in-vehicle device determines that an in-vehicle ECU is not operating normally, for example, if the state data cannot be acquired beyond the transmission period, if the acquired state data includes an abnormality code indicating an abnormality in the in-vehicle ECU that is the transmission source, if it is determined that the acquired state data is invalid data, for example, due to spoofing, or the like. Cases where the in-vehicle ECU is not operating normally include a case where the in-vehicle ECU has failed or a case where the in-vehicle ECU has been removed from the vehicle, for example. The control unit of the in-vehicle device specifies a redundant ECU (proxy ECU) to substitute for the in-vehicle ECU determined not to be operating normally. The redundant ECU is, for example, an in-vehicle ECU of the same model as or compatible with the in-vehicle ECU determined not to be operating normally. The redundant ECU can provide various services or functions provided by the in-vehicle ECU determined not to be operating normally by executing software that is the same as or compatible with the software executed by that in-vehicle ECU. The control unit of the in-vehicle device performs startup processing such as transmitting a wake-up signal to the specified redundant ECU, or processing for causing the specified redundant ECU to substitute (act as a proxy) for the in-vehicle ECU determined not to be operating normally, such as transmitting (outputting) an instruction signal to instruct the start of substitution (the start of acting as a proxy). As a result, the redundant ECU that has received instructions from the in-vehicle device begins processing (substitution processing) for substituting for the in-vehicle ECU determined not to be operating normally, and therefore the service or function provided by that in-vehicle ECU can continue. In addition, it is possible to suppress the necessary amount of signal lines in a harness or the like that is necessary for connection to the sensors and the like by substituting for the in-vehicle ECU that performs transmission and reception with the sensor/actuator control ECU, without performing duplication of the in-vehicle ECU (sensor/actuator control ECU) to which the sensors and the like are connected.

In the in-vehicle device according to an aspect of the present disclosure, the control unit acquires software to be executed by the in-vehicle ECU determined not to be operating normally, and the control unit performs processing for causing the redundant ECU to perform substitution by outputting the acquired software to the redundant ECU.

In this aspect, the control unit of the in-vehicle device acquires software executed by the in-vehicle ECU determined not to be operating normally. The software may be acquired from, for example, an external server such as an Over The Air (OTA) server located outside the vehicle. Alternatively, the software may be stored in advance in a storage region accessible by the control unit of the in-vehicle device, such as the storage unit of the in-vehicle device, and the software may be acquired by accessing the storage region. The control unit of the in-vehicle device transmits (outputs) software acquired from, for example, an external server to the specified redundant ECU. The redundant ECU can acquire software from the in-vehicle device and install (apply) the acquired software to execute the software, thereby enabling efficient performance of substitution processing. That is, when the redundant ECU substitutes for one of the in-vehicle ECUs, it is possible to eliminate the need to hold (store) the software of that in-vehicle ECU in advance, and this makes it possible to suppress a case in which the storage region of the redundant ECU becomes full. Furthermore, when substituting for an in-vehicle ECU, the latest version of the software acquired from the external server or the like can be applied to the redundant ECU.

In the in-vehicle device according to an aspect of the present disclosure, the state data acquired from the in-vehicle ECU includes setting information related to an operation setting of the in-vehicle ECU at the time of transmitting the state data, and the control unit performs the processing for causing the redundant ECU to perform substitution by outputting the setting information to the redundant ECU.

In this aspect, the state data that the in-vehicle ECU periodically, regularly, or constantly outputs (transmits) to the in-vehicle device includes setting information related to the operation setting of the in-vehicle ECU at the time when the state data is transmitted. The in-vehicle ECU provides a service or function by executing software, and the setting information corresponds to, for example, various types of setting information for providing the service or function. The setting information may include, for example, user information related to a driver who is driving the vehicle, and may further include setting information associated with each piece of user information (setting information for each driver). Furthermore, the setting information may include history information such as the content of operations performed when the driver (current user) currently driving the vehicle uses a service or the like. The control unit of the in-vehicle device outputs (transmits), to the redundant ECU, the software necessary for the redundant ECU to substitute for the in-vehicle ECU, as well as setting information related to the operation setting of the in-vehicle ECU at the time when the state data is transmitted from the in-vehicle ECU. By acquiring software and setting information from the in-vehicle device, the redundant ECU can execute software with the setting information reflected, and can inherit the operation setting of the in-vehicle ECU that is to be substituted for, thereby making it possible to continue to provide the service or function.

In the in-vehicle device according to an aspect of the present disclosure, the control unit uses a relay table stored in an accessible storage region to perform processing for relaying messages transmitted and received between a plurality of the in-vehicle ECUs, and the control unit changes the relay table according to the specified redundant ECU.

In this aspect, a relay table is stored in a storage region accessible to the control unit of the in-vehicle device, such as the storage unit of the in-vehicle device, and the control unit of the in-vehicle device refers to the relay table to perform processing for relaying messages transmitted and received between the plurality of in-vehicle ECUs. That is, the in-vehicle device includes a plurality of in-vehicle communication units corresponding to a physical layer of each communication protocol, such as a CAN transceiver or an Ethernet PHY unit, and functions as a relay device (CAN gateway, Ethernet switch) that relays messages transmitted and received by each of the in-vehicle ECUs connected to each of the plurality of in-vehicle communication units. When the redundant ECU substitutes for the in-vehicle ECU determined not to be operating normally, it is assumed that the address of the redundant ECU and the address of the in-vehicle ECU on the in-vehicle network will be different from each other. In addition, when relaying a message (frame) such as a CAN message, if the in-vehicle ECU that is the relay destination is specified according to the identifier (message ID) of the message, it is assumed that it will be necessary to change the relay destination from the in-vehicle ECU determined not to be operating normally, to the redundant ECU. Even if the addresses of the redundant ECU and the in-vehicle ECU are different in this way, the control unit of the in-vehicle device changes the relay table according to the specified redundant ECU, and therefore messages and the like required when executing the service or function can be reliably relayed to the redundant ECU instead of the in-vehicle ECU to be substituted for.

In the in-vehicle device according to an aspect of the present disclosure, a substitution table related to substitution performed by each of a plurality of the redundant ECUs is stored in a storage region that is accessible by the control unit, and the control unit specifies one of the plurality of redundant ECUs by referring to the substitution table.

In this aspect, the vehicle is equipped with a plurality of redundant ECUs. These redundant ECUs may be constituted by backup ECUs that are retrofitted to the vehicle in order to add new services or functions. That is, each of the retrofitted plurality of backup ECUs may function as a redundant ECU that is to substitute for another backup ECU, thereby forming a group of redundant ECUs. In the storage region accessible by the control unit of the in-vehicle device, such as a storage unit of the in-vehicle device, information related to substitution performed by each of the plurality of redundant ECUs is stored, for example, in table format (substitution table). The substitution table stores, for example, information related to the association of one or more redundant ECUs corresponding to various services or functions. The control unit of the in-vehicle device refers to the substitution table to specify the redundant ECU that corresponds to the in-vehicle ECU to be substituted for (the in-vehicle ECU determined not to be operating normally), and therefore even if the vehicle is equipped with a plurality of redundant ECUs, the control unit of the in-vehicle device can efficiently specify the appropriate redundant ECU.

In the in-vehicle device according to an aspect of the present disclosure, the redundant ECU is configured to be additionally attached after production of the vehicle, when the redundant ECU is attached to the vehicle, the redundant ECU outputs substitution information related to substitution performed by the redundant ECU, and the control unit changes the substitution table according to the substitution information acquired from the redundant ECU.

In this aspect, the redundant ECU is configured to be additionally attached after production of the vehicle. That is, the backup ECU that functions as the redundant ECU is configured to be detachable so as to support attachment and removal after production of the vehicle. When the redundant ECU (backup ECU) is attached to the vehicle, that is, when it is connected to the in-vehicle network, the redundant ECU outputs (transmits) substitution information related to substitution performed by the redundant ECU itself, to the in-vehicle device. When the redundant ECU (backup ECU) is attached to the vehicle, it may first acquire management information of the in-vehicle ECU from the in-vehicle device, and then output (transmit) substitution information to the in-vehicle device based on the acquired management information. The control unit of the in-vehicle device can recognize that the redundant ECU is mounted in the vehicle by acquiring (receiving) the substitution information from the redundant ECU. Then, by referring to the substitution information, the in-vehicle device can recognize the services and the like that can be provided by the newly mounted redundant ECU, or the in-vehicle ECU that the redundant ECU can substitute for. The control unit of the in-vehicle device changes the management information (ECU state table) and the substitution table of the in-vehicle ECU based on the substitution information acquired from the newly-mounted redundant ECU. This allows the control unit of the in-vehicle device to constantly monitor the latest information related to the redundant ECUs (backup ECUs) connected to the in-vehicle network, and to specify the appropriate redundant ECU for the in-vehicle ECU determined not to be operating normally.

In the in-vehicle device according to an aspect of the present disclosure, if there are a plurality of candidates for the redundant ECU to substitute for the in-vehicle ECU determined not to be operating normally, the control unit specifies one of the redundant ECUs based on current processing loads of the plurality of redundant ECUs that are candidates.

In this aspect, the vehicle is equipped with the plurality of redundant ECUs. The plurality of redundant ECUs can provide the same services or functions by executing the same or compatible software. In this case, if it is determined that any one of the in-vehicle ECUs is not operating normally, it is assumed that there are a plurality of redundant ECUs that can substitute for the in-vehicle ECU (redundant ECUs that are substitution candidates). In this manner, if there are a plurality of candidates for the redundant ECU (redundant ECUs that are substitution candidates), the control unit of the in-vehicle device specifies, among the plurality of redundant ECUs that are substitution candidates, the redundant ECU with the lowest processing load, for example, as the redundant ECU to substitute for the in-vehicle ECU determined not to be operating normally, based on the current processing loads of these redundant ECUs. For example, the state data transmitted from the in-vehicle ECU includes information related to the processing load of the in-vehicle ECU at the time of transmission, and the control unit of the in-vehicle device can ascertain the current processing load of the in-vehicle ECU that is the transmission source of the state data based on the information related to the processing load included in the acquired state data. In this way, even if there are a plurality of redundant ECUs that are substitution candidates, it is possible to cause each of the redundant ECUs to operate in such a way that the respective processing loads of the redundant ECUs are balanced.

In the in-vehicle device according to an aspect of the present disclosure, if there are a plurality of candidates for the redundant ECU to substitute for the in-vehicle ECU determined not to be operating normally, the control unit specifies one of the redundant ECUs based on substitution capacities of the plurality of redundant ECUs that are candidates.

In this aspect, if there are a plurality of candidates for the redundant ECU (redundant ECUs that are substitution candidates), the control unit of the in-vehicle device specifies, based on the substitution capacities of these redundant ECUs, for example, the redundant ECU with the lowest substitution capacity as the redundant ECU to substitute for the in-vehicle ECU determined not to be operating normally. The substitution capacity of a redundant ECU corresponds to the number of in-vehicle ECUs that the redundant ECU can substitute for, or the number of types of services, functions, and the like provided by the in-vehicle ECU that the redundant ECU can substitute for. That is, it is assumed that differences in versatility will arise among the plurality of redundant ECUs mounted in the vehicle based on the product specifications or characteristics of each of these redundant ECUs. A redundant ECU with relatively high versatility can support a wide variety of services or functions, or in other words, can execute a wide variety of software to provide a wide variety of services or functions, and can therefore substitute for a large number of in-vehicle ECUs. In contrast, a redundant ECU that has relatively low versatility can, for example, only support one or a few types of services or functions, that is, it can only execute software for providing a specific service or function, and can therefore substitute for one or a few types of in-vehicle ECUs. Even in such a case, if there are a plurality of redundant ECUs that are substitution candidates, the control unit of the in-vehicle device will preferentially specify the redundant ECU with the lowest substitution capacity, thereby preserving the redundant ECUs with relatively high versatility. As a result, in an in-vehicle system including a plurality of redundant ECUs, even if there are a plurality of in-vehicle ECUs to be substituted for, it is possible to specify a redundant ECU for each of the plurality of in-vehicle ECUs in a balanced manner, thereby improving the availability of the in-vehicle system.

In the in-vehicle device according to an aspect of the present disclosure, the control unit functions as the redundant ECU.

In this aspect, the control unit of the in-vehicle device functions as a redundant ECU (a control unit of a redundant ECU), that is, the in-vehicle device functions as a state management device that manages the states of the plurality of in-vehicle ECUs, and also functions as a redundant ECU that substitutes for an in-vehicle ECU determined not to be operating normally. A virtualization system such as a hypervisor may be applied to the in-vehicle device, and the in-vehicle device may function as a state management device and a redundant ECU by operating as a plurality of virtual environments (virtual machines) generated by the virtualization system. By including a redundant ECU in the in-vehicle device in this manner, surplus resources of the in-vehicle device, that is, free time in the control unit of the in-vehicle device, can be allocated to processing by the redundant ECU.

A program according to an aspect of the present disclosure is a program for causing a computer that is communicably connected to a plurality of in-vehicle ECUs to execute processing for: acquiring state data related to states of the in-vehicle ECUs from the in-vehicle ECUs; specifying, if it is determined based on the acquired state data that an in-vehicle ECU of the in-vehicle ECUs is not operating normally, a redundant ECU to substitute for the in-vehicle ECU determined not to be operating normally; and causing the redundant ECU to substitute for the in-vehicle ECU determined not to be operating normally.

In this aspect, it is possible to provide a program that causes a computer to function as an in-vehicle device that efficiently performs processing related to substituting for an in-vehicle ECU mounted in a vehicle when the in-vehicle ECU stops operating normally.

An information processing method according to an aspect of the present disclosure is an information processing method for causing a computer that is communicably connected to a plurality of in-vehicle ECUs to execute processing for: acquiring state data related to states of the in-vehicle ECUs from the in-vehicle ECUs; specifying, if it is determined based on the acquired state data that an in-vehicle ECU of the in-vehicle ECUs is not operating normally, a redundant ECU to substitute for the in-vehicle ECU determined not to be operating normally; and causing the redundant ECU to substitute for the in-vehicle ECU determined not to be operating normally.

In this aspect, it is possible to provide an information processing method that causes a computer to function as an in-vehicle device that efficiently performs processing related to substituting for an in-vehicle ECU mounted in a vehicle when the in-vehicle ECU stops operating normally.

The present disclosure will be specifically described with reference to drawings showing embodiments thereof. An in-vehicle device 2 according to an embodiment of the present disclosure will be described below with reference to the drawings. Note that the present disclosure is not limited to these examples, but is indicated by the claims, and is intended to encompass all modifications within the meaning and scope equivalent to the claims.

### First Embodiment

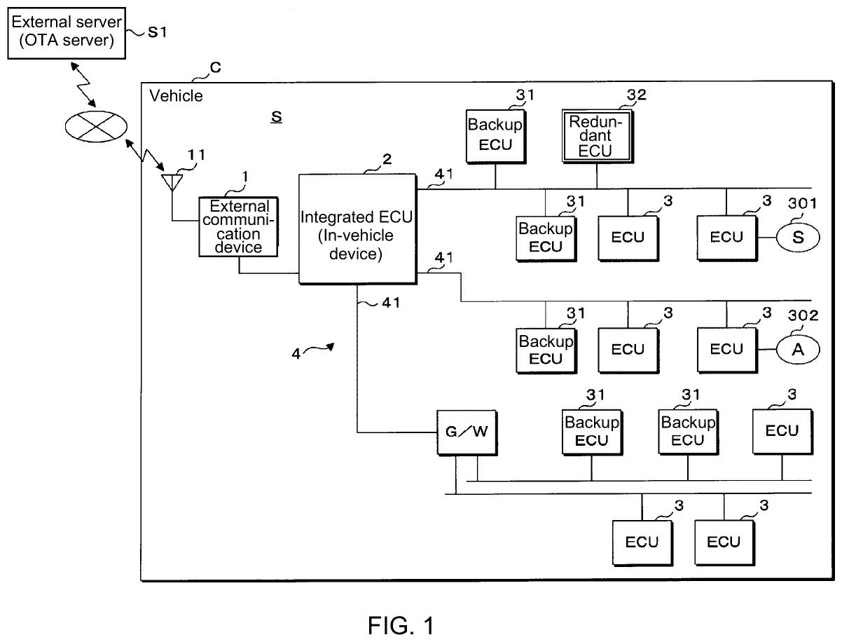

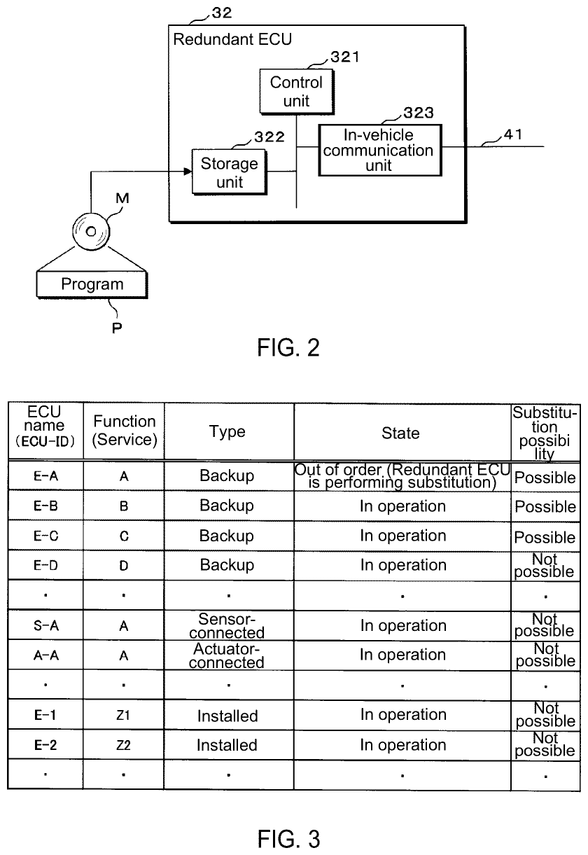

Hereinafter, an embodiment will be described with reference to the drawings. FIG. 1 is a schematic diagram illustrating a system configuration of an in-vehicle system S according to a first embodiment. FIG. 2 is a block diagram illustrating an example of an internal configuration of the in-vehicle device 2 (integrated ECU). The in-vehicle system S is configured with the in-vehicle device 2 and redundant ECUs 32 mounted in a vehicle C as main devices, and the in-vehicle device 2 is communicably connected to a plurality of in-vehicle ECUs 3 including backup ECUs 31 and redundant ECUs 32 via an in-vehicle network 4. The in-vehicle device 2 may have a relay function and relay messages transmitted and received by each of the in-vehicle ECUs 3. Alternatively, a relay device such as a CAN gateway or an Ethernet switch may be connected under the control of the in-vehicle device 2, and may perform relay processing of messages transmitted and received by each of the in-vehicle ECUs 3.

Furthermore, the in-vehicle device 2 is connected via an exterior communication device 1 to an external server S1, such as an Over The Air (OTA) server, which is connected to an exterior network such as the Internet, so as to be able to communicate with the external server S1. The exterior communication device 1 includes an exterior communication unit and an input/output I/F (interface) for communicating with the in-vehicle device 2. The exterior communication unit is a communication device for wireless communication using mobile communication protocols such as LTE, 4G, 5G, and WiFi, and transmits and receives data to and from the external server S1 via an antenna 11 connected to the exterior communication unit. The communication between the exterior communication device 1 and the external server S1 is performed via an external network such as a public communication network or the Internet.

The in-vehicle ECUs 3 include not only the in-vehicle ECUs 3 that are mounted during the production stage of the vehicle C (installed at the time of shipment), but also backup ECUs 31 that are retrofitted (attached after the production and shipment of the vehicle C) when adding a new service or function to the vehicle C. The backup ECUs 31 may include a backup ECU 31 (a redundant ECU 32) that has a function of substituting for another in-vehicle ECU 3 (a backup ECU 31). The in-vehicle ECUs 3 installed at the time of shipment include in-vehicle ECUs 3 (sensor/actuator control ECUs) to which a sensor 301 or an actuator 302 is directly connected via a signal line or the like, and in-vehicle ECUs 3 to which this type of sensor 301 or the like is not directly connected and which output computation results and the like obtained by performing information processing based on messages and the like acquired from these sensor/actuator control ECUs.

By additionally connecting (newly installing) the backup ECUs 31 to the in-vehicle network 4 in this manner, a new service or function can be added to the vehicle C. The additionally-connected (newly-installed) backup ECUs 31 may include a redundant ECU 32 (proxy ECU) that has the function of substituting for (acting as a proxy for) another in-vehicle ECU 3 by executing the same software as the other in-vehicle ECU 3. By using the redundant ECUs 32, even if the added backup ECUs 31 or the in-vehicle ECUs 3 installed at the time of shipment no longer operate normally, it is possible to substitute for the in-vehicle ECUs 3 and continue or resume the provision of services and the like that had been provided by the in-vehicle ECUs 3.

The in-vehicle device 2 is an integrated ECU that includes a control unit 21, a storage unit 22, and in-vehicle communication units 23, is configured by, for example, a central control device such as a vehicle computer, and performs overall control of the vehicle C. The in-vehicle device 2 may have a plurality of in-vehicle communication units 23 and function as a relay device that relays messages and the like transmitted and received between the in-vehicle ECUs 3 connected to the respective in-vehicle communication units 23. Alternatively, a plurality of individual ECUs may be connected under the control of the in-vehicle device 2 functioning as an integrated ECU, and the in-vehicle device 2 may control the relay function and the like of these individual ECUs. The in-vehicle device 2 acquires and aggregates state data periodically transmitted from the plurality of in-vehicle ECUs 3 connected to the in-vehicle network 4, thereby performing processing related to state management of the in-vehicle ECUs 3.

The control unit 21 is constituted by a central processing unit (CPU), a micro processing unit (MPU), or the like, and is configured to perform various types of control processing, computation processing, and the like by reading out and executing a program P (program product) and data stored in advance in the storage unit 22. The control unit 21 is not limited to a software processing unit that performs software processing such as a CPU, but may also include a hardware processing unit that performs various types of control processing, computation processing, and the like using hardware processing, such as an FPGA, ASIC, or SOC.

The storage unit 22 is constituted by a volatile memory element such as a random access memory (RAM) or a non-volatile memory element such as a read only memory (ROM), an electrically erasable programmable ROM (EEPROM), or a flash memory, and stores in advance the program P (program product) and data to be referred to during processing. The program P (program product) stored in the storage unit 22 may be a program P (program product) read out from a recording medium M that is readable by the in-vehicle device 2. In addition, the program P (program product) may be downloaded from an external computer (not shown) connected to a communication network (not shown) and stored in the storage unit 22. The storage unit 22 may further store an ECU state table, a substitution table, and a relay table. These tables will be described in detail later.

The in-vehicle communication unit 23 is, for example, an input/output interface (CAN transceiver, Ethernet PHY) using a communication protocol such as control area network (CAN), CAN-FD, or Ethernet (registered trademark). A communication line 41 such as a CAN bus or an Ethernet cable is connected to the in-vehicle communication unit 23 according to a communication protocol. The control unit 21 communicates with the in-vehicle ECUs 3, such as the backup ECUs 31 and the redundant ECUs 32, which are connected to the in-vehicle network 4 via the in-vehicle communication unit 23.

Similarly to the in-vehicle device 2, the in-vehicle ECUs 3 such as the redundant ECUs 32 and the backup ECUs 31 each include a control unit, a storage unit, and an in-vehicle communication unit. These in-vehicle ECUs 3 may be started up or stopped (put in a standby state) in response to a wake-up signal or a sleep signal transmitted from the in-vehicle device 2.

FIG. 3 is an explanatory diagram illustrating an example of the ECU state table. The storage unit 22 of the in-vehicle device 2 stores, for example, in table format (ECU state table) information in which state information of the in-vehicle ECUs 3 is aggregated based on state data acquired from the plurality of in-vehicle ECUs 3 including the backup ECUs 31, the redundant ECUs 32, and the sensor/actuator control ECUs, the information being related to the current state management of the in-vehicle ECUs 3. The ECU state table includes, as management items (fields), for example, “ECU name”, “function”, “type”, “state”, and “processing load”. The “ECU name” management item stores, for example, an identification number or the like that uniquely identifies the in-vehicle ECU 3, such as an ECU number or an ECU name.

The “function” management item stores the name (function name) of a function, service, or the like that is implemented or provided by the in-vehicle ECU 3 (ECU name) stored in the same record by executing software. A redundant ECU 32 or the in-vehicle device 2 can specify another in-vehicle ECU 3 (the in-vehicle ECU 3 to be substituted for) that the redundant ECU 32 can substitute for, based on the function name.

The “type” management item stores the type of the in-vehicle ECU 3 (ECU name) stored in the same record. The type includes, for example, “backup”, “redundant backup”, “sensor-connected”, “actuator-connected”, and “installed”.

An in-vehicle ECU 3 whose type is “backup” indicates a backup ECU 31, which is an in-vehicle ECU 3 that can be retrofitted (attached after production and shipment of the vehicle C) when adding a new service or function to the vehicle C, for example. An in-vehicle ECU 3 whose type is “redundant backup” indicates a redundant ECU 32, which is an in-vehicle ECU 3 that can substitute for another in-vehicle ECU 3 among the backup ECUs 31 that can be retrofitted.

An in-vehicle ECU 3 whose type is “sensor-connected” is an in-vehicle ECU 3 to which a sensor 301 such as a LiDAR, an infrared sensor 301, or a CMOS camera is directly connected via a signal line or the like. An in-vehicle ECU 3 whose type is “actuator-connected” is an in-vehicle ECU 3 to which an actuator 302 such as a switch, a lamp, or a drive motor is directly connected via a signal line or the like. An in-vehicle ECU 3 whose type is “installed” is an in-vehicle ECU 3 that is mounted in the vehicle C during the production stage of the vehicle C (an in-vehicle ECU 3 that is installed at the time of shipment).

The “state” management item stores the operation state of the in-vehicle ECU 3 (ECU name) stored in the same record. The operation state includes, for example, “in operation”, which indicates being in normal operation, “out of order”, which indicates abnormal operation, “in redundant operation”, which indicates performing substitution processing, and “on standby”, which indicates a sleep state or the like. When a state of “in redundant operation” is indicated, information indicating which in-vehicle ECU 3 is being substituted for (e.g., ECU name=A is being substituted for) may be added.

The management item for the processing load stores the usage state of the hardware resources of the in-vehicle ECU 3 (ECU name) stored in the same record. The usage state of the hardware resources includes, for example, the CPU usage rate or the memory usage rate.

The control unit 21 of the in-vehicle device 2 updates the operation state of each of the in-vehicle ECUs 3 based on the state data periodically acquired from each of the in-vehicle ECUs 3. Accordingly, the control unit 21 of the in-vehicle device 2 can ascertain the current operation state and processing load of each of the in-vehicle ECUs 3, using the transmission period (reception period) of the state data as the processing unit time.

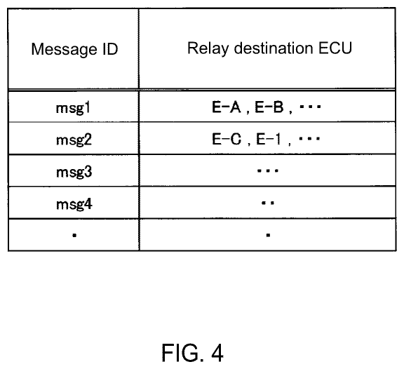

FIG. 4 is an explanatory diagram illustrating an example of the substitution table. For each of the in-vehicle ECUs 3 including the backup ECUs 31, the storage unit 22 of the in-vehicle device 2 stores information indicating which redundant ECUs 32 can substitute for that in-vehicle ECU 3 in, for example, table format (substitution table). The control unit 21 of the in-vehicle device 2 may update the substitution table based on substitution capacity information, product specification information, or the like transmitted from the newly installed backup ECUs 31, redundant ECUs 32 (backup ECUs 31 whose type is “redundant backup”), and the like.

The substitution table includes, as management items (fields), for example, “substitution target ECU” and “redundant ECU name”. The “substitution target ECU” management item stores the ECU name of the in-vehicle ECU 3 that is to be substituted for if it is determined that the in-vehicle ECU 3 is not operating normally. The ECU name is the ECU name defined in the ECU state table, and the substitution table is normalized accordingly.

The “redundant ECU name” management item stores the ECU name of the redundant ECU 32 that can substitute for the in-vehicle ECU 3 whose ECU name is stored in the same record. That is, the ECU name of the redundant ECU 32 that is capable of executing software that is the same as or compatible with the software executed by the in-vehicle ECU 3 having the substitution target ECU name and is thus capable of providing the same services or functions as the in-vehicle ECU 3 is stored.

The number of redundant ECUs 32 capable of substituting for any one of the in-vehicle ECUs 3 (substitution target ECU name) such as the backup ECUs 31 is not limited to one, and there may be a plurality of redundant ECUs 32 capable of substituting. Accordingly, the redundant ECUs 32 include a redundant ECU 32 that can substitute for only one in-vehicle ECU 3 (backup ECU 31), or a redundant ECU 32 that can substitute for a plurality of in-vehicle ECUs 3 (backup ECUs 31). That is, the versatility of the redundant ECUs 32 varies based on the product specification or characteristics of each redundant ECU 32, but by referring to the substitution table, the number of substitutable in-vehicle ECUs 3 (the substitution capacity) for each redundant ECU 32 can be ascertained efficiently.

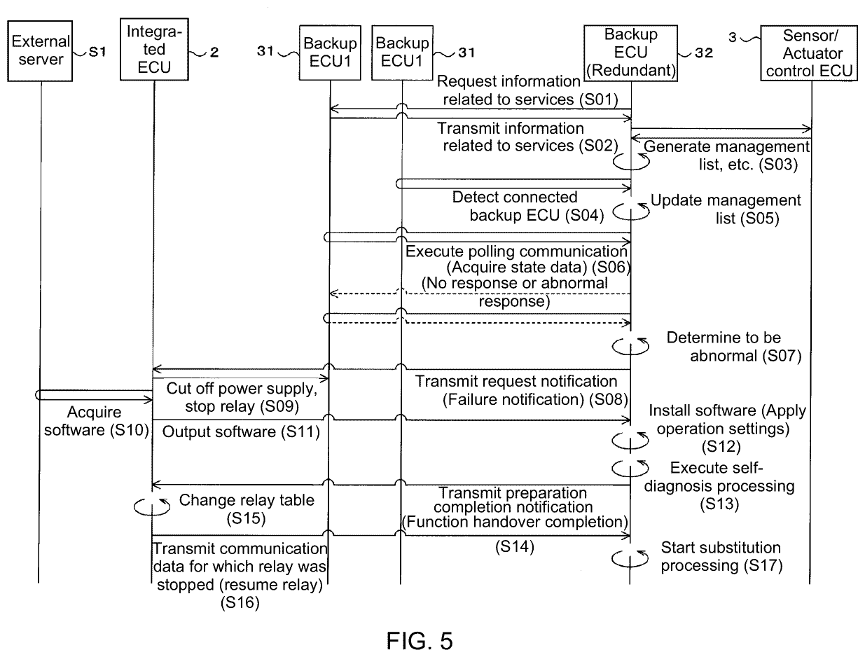

FIG. 5 is an explanatory diagram illustrating an example of the relay table. The in-vehicle device 2 functioning as a relay device performs relay processing of messages transmitted and received between a plurality of in-vehicle ECUs 3 by referring to the relay table stored in the storage unit 22. Alternatively, the in-vehicle device 2 may transmit route information extracted by referring to the relay table to another relay device such as a CAN gateway connected to the in-vehicle network 4, in response to an inquiry from the other relay device. The relay table includes, as management items (fields), for example, “message ID” and “relay destination ECU”.

The “message ID” management item stores an identifier indicating the type of communication data, such as a message, frame, or packet, to be relayed, and the like. For example, if the communication protocol is CAN or CAN/FD, a CAN-ID may be stored in the message ID. If the communication protocol is TCP/IP, a TCP port number or a UDP port number may be stored in the message ID.

The “relay destination ECU” management item stores the ECU name of the in-vehicle ECU 3 that is the relay destination of the communication data (message, etc.) of the message ID stored in the same record. When the control unit 21 of the in-vehicle device 2 applies the redundant ECU 32 (starts substitution processing), it changes the relay table according to the redundant ECU 32, and therefore it can reliably relay messages and the like required when executing a service or function to the redundant ECU 32 instead of the in-vehicle ECU 3 to be substituted for.

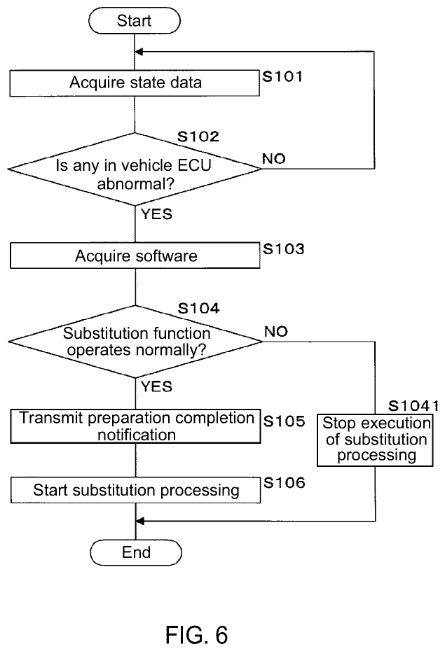

FIG. 6 is an explanatory diagram illustrating a flow (sequence) of processing of the in-vehicle device 2, the redundant ECU 32, and the like. The in-vehicle device 2, the backup ECU 31, and the redundant ECU 32 included in the in-vehicle system S are communicably connected via the in-vehicle network 4, and perform the following processing in association with each other.

The in-vehicle device 2 periodically, regularly, or constantly performs polling communication or the like (state inquiry) with the in-vehicle ECU 3 including the backup ECU 31 and the redundant ECU 32, and acquires state data related to the state of the in-vehicle ECU 3 (step S01). A plurality of in-vehicle ECUs 3 including a backup ECU 31 and a redundant ECU 32 are connected to the in-vehicle network 4, and the in-vehicle device 2 continuously carries out state inquiries on the in-vehicle ECUs 3 through polling communication or the like with the plurality of in-vehicle ECUs 3. The in-vehicle device 2 can recognize whether the in-vehicle ECU 3 is operating or stopped (removed from the in-vehicle network 4) based on whether or not it has acquired state data periodically transmitted from the plurality of in-vehicle ECUs 3.

Furthermore, when a backup ECU 31 (including a redundant ECU 32, which is a redundant backup ECU 31) is newly connected to (newly installed in) the in-vehicle network 4, the in-vehicle device 2 can recognize that the backup ECU 31 has been newly connected to the in-vehicle network 4 by acquiring state data from the newly-installed backup ECU 31. When a new service or function is added to the vehicle C, it is assumed that the backup ECU 31 will be retrofitted (attached after the production and shipment of the vehicle C). In this way, even when the backup ECU 31 is retrofitted accompanying the addition of a service, the in-vehicle device 2 can detect, in a timely manner, that the backup ECU 31 has been newly installed.

The state data output (transmitted) from the in-vehicle ECU 3 includes information indicating whether the in-vehicle ECU 3 is operating normally (normal operation) and information indicating that the in-vehicle ECU 3 is not operating normally and is in an abnormal state (abnormal operation). Accordingly, based on the state data acquired from the in-vehicle ECU 3, the in-vehicle device 2 can determine the operation state of the in-vehicle ECU 3, that is, whether or not the in-vehicle ECU 3 is operating normally (abnormal operation).

The in-vehicle device 2 updates the management information (ECU state table) of the in-vehicle ECU 3 based on the state data acquired from the in-vehicle ECU 3 (step S02). The in-vehicle device 2 stores the state data acquired from the in-vehicle ECU 3 in the storage unit 22 of the in-vehicle device 2. In this storage processing, the in-vehicle device 2 may update the management information (ECU state table) of the in-vehicle ECU 3 to the latest state by storing the operation state (normal or abnormal), operation settings, and processing load of the in-vehicle ECU 3 included in the state data acquired from the in-vehicle ECU 3 in the ECU state table.

The operation settings of the in-vehicle ECU 3 correspond to various types of setting information (information related to operation settings) of the software when the in-vehicle ECU 3 provides a service or the like by executing the software. The various types of setting information of the software may include, for example, user information related to the driver driving the vehicle C, and may further include setting information associated with respective pieces of user information (setting information for each driver). Furthermore, the operation settings (various types of setting information of software) of the in-vehicle ECU 3 may include history information such as contents of operations performed by the driver (current user) currently driving the vehicle C when using a service or the like. The processing load of the in-vehicle ECU 3 may include, for example, the usage state (CPU usage rate, memory usage rate) of hardware resources such as a CPU and memory that the in-vehicle ECU 3 uses when executing software.

The redundant ECU 32 (newly-installed redundant backup ECU 3) newly connected to the in-vehicle network 4 acquires management information from the in-vehicle device 2 and specifies a substitutable in-vehicle ECU 3 (backup ECU 31) (step S03). For example, if a redundant ECU 32 (newly-installed redundant backup ECU 3) is newly connected to the in-vehicle network 4, the redundant ECU 32 (newly-installed redundant backup ECU 3) communicates with the in-vehicle device 2 and obtains management information (ECU state table) from the in-vehicle device 2. As described above, the management information (ECU state table) includes information related to all the in-vehicle ECUs 3 (including existing backup ECUs 31) connected to the in-vehicle network 4. The information includes, for example, items related to the functions or services that each of the in-vehicle ECUs 3 can provide. Furthermore, the information may include, for example, items related to the software executed by each of the in-vehicle ECUs 3 (the software name, version, etc.). The redundant ECU 32 (newly-installed redundant backup ECU 3) determines which in-vehicle ECU 3 (including an existing backup ECU 31) can be substituted for by referring to the management information (ECU state table) from the in-vehicle device 2, and specifies the substitutable in-vehicle ECU 3.

The redundant ECU 32 newly connected to the in-vehicle network 4 transmits information related to the specified substitutable in-vehicle ECU 3 to the in-vehicle device 2 (step S04). The redundant ECU 32 (newly-installed redundant backup ECU 3) transmits, to the in-vehicle device 2, for example, the ECU name, function name, and the like of the in-vehicle ECU 3 as information related to the specified substitutable in-vehicle ECU 3.

The in-vehicle device 2 updates the management information (ECU state table) and the substitution table based on the information acquired from the redundant ECU 32 (information related to the specified substitutable in-vehicle ECU 3) (step S05). The in-vehicle device 2 updates the management information (ECU state table) and the substitution table based on information (the ECU name, function name, and the like of the substitutable in-vehicle ECU 3) acquired from the redundant ECU 32 (newly-installed redundant backup ECU 3). By updating the substitution table, the newly-installed redundant ECU 32 (newly-installed redundant backup ECU 3) is reflected in the substitution table. By updating the management information (ECU state table), the item related to the operation state of the newly installed redundant ECU 32 (newly-installed redundant backup ECU 3) is reflected in the ECU state table.

The in-vehicle device 2 performs polling communication and the like (state inquiry) on the backup ECU 31 (existing backup ECU 1) and acquires state data (normal response, operation settings) related to the state of the backup ECU 31 (existing backup ECU 1) (step S06). The in-vehicle device 2 determines that the backup ECU 31 (existing backup ECU 1) is abnormal depending on whether or not the state data has been acquired, or based on the acquired abnormal response (step S07). As described above, the in-vehicle device 2 performs polling communication and the like (state inquiry) on all of the in-vehicle ECUs 3 connected to the in-vehicle network 4, and, for example, acquires the latest operation settings of the backup ECUs 31 (existing backup ECUs 1). Then, if any problem occurs in a backup ECU 31 (existing backup ECU 1), the in-vehicle device 2 determines that the backup ECU 31 (existing backup ECU 1) is abnormal based on whether or not there is state data from the backup ECU 31 (existing backup ECU 1), or based on the content of the state data.

If the in-vehicle device 2 does not acquire state data from the backup ECU 31 (existing backup ECU 1) beyond the transmission period, the in-vehicle device 2 may determine that the backup ECU 31 (existing backup ECU 1) has failed or has been removed from the in-vehicle network 4 and is not operating normally. When the state data acquired from the backup ECU 31 (existing backup ECU 1) indicates an abnormal response, the in-vehicle device 2 may determine that the backup ECU 31 (existing backup ECU 1) is not operating normally.

The in-vehicle device 2 outputs a startup signal (WakeUp instruction) to the redundant ECU 32 (newly-installed redundant backup ECU 3) (step S08). For example, by referring to the substitution table, the in-vehicle device 2 specifies the redundant ECU 32 (newly-installed redundant backup ECU 3) that can substitute for the in-vehicle ECU 3 determined not to be operating normally, that is, the backup ECU 31 (existing backup ECU 1) to be substituted for. The in-vehicle device 2 outputs a startup signal (WakeUp instruction) to the specified redundant ECU 32 (newly-installed redundant backup ECU 3), thereby starting up the redundant ECU 32 (newly-installed redundant backup ECU 3).

The redundant ECU 32 (newly-installed redundant backup ECU 3) outputs a startup completion notification to the in-vehicle device 2 (step S09). For example, the redundant ECU 32 (newly-installed redundant backup ECU 3), which has been in a paused or standby state (sleep state), starts startup processing in response to a startup signal (Wake Up instruction) from the in-vehicle device 2. The redundant ECU 32 (newly-installed redundant backup ECU 3), which has completed the startup processing and is in a started-up state (wake-up state), outputs a startup completion notification to the in-vehicle device 2. The in-vehicle device 2 can recognize that the redundant ECU 32 (newly-installed redundant backup ECU 3) has been started up by acquiring the startup completion notification from the redundant ECU 32 (newly-installed redundant backup ECU 3).

The in-vehicle device 2 acquires software for substituting for the backup ECU 31 (existing backup ECU 1) determined to be abnormal from the external server S1 (step S10). The in-vehicle device 2 acquires software for substituting for the backup ECU 31 (existing backup ECU 1) determined to be abnormal, from an external server S1 functioning as an OTA server, for example. For example, by referring to an ECU state table, the in-vehicle device 2 may specify the function performed or software provided by the backup ECU 31 (existing backup ECU 1) determined not to be operating normally, and acquire (download) the software from the external server S1 by transmitting a request signal including information related to the specified function or software to the external server S1.

The in-vehicle device 2 outputs the software and operation settings to the redundant ECU 32 (newly-installed redundant backup ECU 3) (step S11). The in-vehicle device 2 outputs, to the redundant ECU 32 (newly-installed redundant backup ECU 3), the software acquired (downloaded) from the external server S1 and the operation settings (software setting information) included in the state data last acquired from the backup ECU 31 (existing backup ECU 1) determined not to be operating normally. The state data last acquired from the backup ECU 31 (existing backup ECU 1) corresponds to the state data acquired immediately before it is determined that the backup ECU 31 (existing backup ECU 1) is not operating normally. By using the operation settings (software setting information) included in such state data, it is possible to continue providing services or functions by inheriting the operation settings immediately before it is determined that the backup ECU 31 (existing backup ECU 1) is not operating normally.

The redundant ECU 32 (newly-installed redundant backup ECU 3) installs the software acquired from the in-vehicle device 2 and applies the operation settings (step S12). The redundant ECU 32 (the newly-installed redundant backup ECU 3) installs the software acquired from the in-vehicle device 2. This allows the redundant ECU 32 (newly-installed redundant backup ECU 3) to provide the same service or the like as that provided by the backup ECU 31 (existing backup ECU 1) determined not to be operating normally. Then, the redundant ECU 32 (newly-installed redundant backup ECU 3) applies the operation settings (software setting information) acquired from the in-vehicle device 2. As a result, the redundant ECU 32 (newly installed redundant backup ECU 3) can inherit the operation settings immediately before the backup ECU 31 (existing backup ECU 1) is determined not to be operating normally, and continue providing the service or function.

The in-vehicle device 2 updates the relay table and the management information (ECU state table) (step S13). The in-vehicle device 2 updates (changes) the relay table in accordance with the redundant ECU 32 (newly-installed redundant backup ECU 3). The in-vehicle device 2 relays messages (frames) transmitted and received between the in-vehicle ECUs 3 using the relay table. In response to this, the in-vehicle device 2 updates the relay table, for example, to change the relay destination for a specific message (frame) from the backup ECU 31 (existing backup ECU 1) determined not to be operating normally to the redundant ECU 32 (newly-installed redundant backup ECU 3). As a result, messages (frames) required for the redundant ECU 32 (newly-installed redundant backup ECU 3) to execute the software are relayed from the in-vehicle ECU 3 that is the transmission source via the in-vehicle device 2. The in-vehicle device 2 may further update the ECU state table to the latest state by storing, in the ECU state table, information indicating that the redundant ECU 32 (newly-installed redundant backup ECU 3) is performing substitution processing and that the backup ECU 31 (existing backup ECU 1) determined not to be operating normally is out of order.

The redundant ECU 32 (newly-installed redundant backup ECU 3) starts processing (substitution processing) for substituting for the backup ECU 31 (existing backup ECU 1) determined to be abnormal (step S14). The redundant ECU 32 (newly-installed redundant backup ECU 3) starts substitution processing for the backup ECU 31 (existing backup ECU 1), whereby it is possible to continue providing the service or function that had been provided by the backup ECU 31 (existing backup ECU 1). This makes it possible to ensure the availability of the in-vehicle system S including the backup ECU 31 and the redundant ECU 32.

In this embodiment, the newly installed redundant ECU 32 (newly-installed redundant backup ECU 3) is initially, that is, at the time of installation, in a standby state (sleep state) without providing any services, and is started up by a startup signal (wake-up signal) from the in-vehicle device 2 and starts substitution processing, but there is no limitation to this. The newly-installed redundant ECU 32 (newly-installed redundant backup ECU 3) may initially, that is, at the time of installation, execute software corresponding to a newly-added service in order to provide that service, for example. Then, when software for substituting for one of the in-vehicle ECUs 3 (an in-vehicle ECU 3 determined not to be operating normally) is acquired from the in-vehicle device 2, the software for the substitution may also be executed, and a plurality of pieces of software may be executed to provide a plurality of services or the like. In this way, for a redundant ECU 32 having a substitution function, other software can be executed to provide a service or the like, even during periods other than when it is substituting for one of the in-vehicle ECUs 3 (an in-vehicle ECU 3 determined not to be operating normally), thereby improving the usage rate of the redundant ECU 32 (promoting effective use of hardware resources).

FIG. 7 is a flowchart illustrating processing of the control unit 21 of the in-vehicle device 2. The control unit 21 of the in-vehicle device 2 (integrated ECU) constantly performs the following processing, for example, when the vehicle C is in a stopped state (power switch or IG switch is off) or in a started-up state (power switch or IG switch is on).

The control unit 21 of the in-vehicle device 2 (integrated ECU) periodically, regularly, or constantly performs polling communication and the like with the in-vehicle ECUs 3 including the backup ECU 31 and the redundant ECU 32 via the in-vehicle network 4, and continues the processing for acquiring state data from these in-vehicle ECUs 3. This enables the control unit 21 of the in-vehicle device 2 to recognize the backup ECU 31 and redundant ECU 32 that have been newly connected to (newly installed in) the in-vehicle network 4, as well as to recognize the in-vehicle ECUs 3 (including the backup ECU 31 and redundant ECU 32) that have been removed from the in-vehicle network 4.

The control unit 21 of the in-vehicle device 2 continuously performs processing for changing (updating) the management information (ECU state table), the substitution table, and the relay table stored in the storage unit 22 in response to recognition of the attachment or removal of these in-vehicle ECUs 3. Then, the control unit 21 of the in-vehicle device 2 performs processing for substituting for the redundant ECU 32 in accordance with the determination of the operation states of the in-vehicle ECUs 3.

The control unit 21 of the in-vehicle device 2 acquires state data from the in-vehicle ECUs 3 via the in-vehicle network 4 (step S101). The control unit 21 of the in-vehicle device 2 periodically, regularly, or constantly acquires, via the in-vehicle network 4, state data from all of the in-vehicle ECUs 3 connected to the in-vehicle network 4. The state data includes information related to the operation state (normal or abnormal), the processing load, and the operation settings (setting information of the software being executed, etc.) of the in-vehicle ECU 3 that is the transmission source.

The control unit 21 of the in-vehicle device 2 may update the ECU state table stored in the storage unit 22 based on the acquired state data. The control unit 21 of the in-vehicle device 2 may use the information stored in the ECU state table updated in this manner to generate screen data showing the state of each of the in-vehicle ECUs 3 connected to the in-vehicle network 4, and output the screen data to a human machine interface (HMI) device such as a display. This allows the operator of the vehicle C to be notified of information related to the state of each of the in-vehicle ECUs 3.

The control unit 21 of the in-vehicle device 2 determines whether or not any of the in-vehicle ECUs 3 is abnormal (S102). Based on the acquired state data, the control unit 21 of the in-vehicle device 2 determines whether or not the in-vehicle ECU 3 that is the transmission source of the state data is abnormal, that is, whether or not the in-vehicle ECU 3 is operating normally. The control unit 21 of the in-vehicle device 2, for example, refers to the ECU state table to determine the operation states of the in-vehicle ECUs 3 of all ECU names included in the ECU state table.

The control unit 21 of the in-vehicle device 2 determines that the in-vehicle ECU 3 is abnormal, for example, if the state data cannot be acquired beyond the transmission period, if the acquired state data includes an abnormality code indicating an abnormality in the in-vehicle ECU 3 that is the transmission source, if it is determined that the acquired state data is invalid data, for example, due to spoofing, or the like. Cases where the in-vehicle ECU 3 is not operating normally (is abnormal) include a case where the in-vehicle ECU 3 has failed or a case where the in-vehicle ECU 3 has been removed from the vehicle C, for example.

If none of the in-vehicle ECUs 3 is abnormal (step S102: NO), the control unit 21 of the in-vehicle device 2 performs loop processing by executing step S101 again. As a result, the control unit 21 of the in-vehicle device 2 continues the processing for acquiring state data from all of the in-vehicle ECUs 3 connected to the in-vehicle network 4. Since the state data includes information related to the current operation settings and processing load of each in-vehicle ECU 3 (at the time when the state data is transmitted), the control unit 21 of the in-vehicle device 2 can acquire the latest operation settings and processing load of each in-vehicle ECU 3. The control unit 21 of the in-vehicle device 2 stores the acquired operation settings and processing loads in the storage unit 22, for example, by storing (updating) them in the ECU state table.

If any of the in-vehicle ECUs 3 is abnormal (S102: YES), the control unit 21 of the in-vehicle device 2 specifies a redundant ECU 32 to substitute for the in-vehicle ECU 3 determined to be abnormal (step S103). For example, by referring to the substitution table or the ECU state table, the control unit 21 of the in-vehicle device 2 specifies a redundant ECU 32 that can substitute for the in-vehicle ECU 3 determined to be abnormal (not operating normally).

The control unit 21 of the in-vehicle device 2 outputs a startup signal to the specified redundant ECU 32 (step S104). The control unit 21 of the in-vehicle device 2 outputs a startup signal, such as a wake-up signal, to the specified redundant ECU 32. For example, the redundant ECU 32 that was in a standby state (sleep state) or the like starts startup (wake-up) processing in response to the startup signal (wake-up signal) from the in-vehicle device 2. When startup is complete, the redundant ECU 32 transmits (outputs) a startup completion notification to the in-vehicle device 2.

The control unit 21 of the in-vehicle device 2 acquires software for substituting for the in-vehicle ECU 3 determined to be abnormal (step S105). For example, by referring to the ECU state table, the control unit 21 of the in-vehicle device 2 ascertains the function performed or the software provided by the in-vehicle ECU 3 determined to be abnormal, and acquires (downloads) the software corresponding to the function from the external server S1.

The control unit 21 of the in-vehicle device 2 determines whether or not a startup completion notification has been received from the redundant ECU 32 (step S106). The control unit 21 of the in-vehicle device 2 determines whether or not a startup completion notification has been acquired (received) from the redundant ECU 32 that has completed startup. If the startup completion notification has not been received (step S106: NO), the control unit 21 of the in-vehicle device 2 performs loop processing by executing step S106 again. As a result, the control unit 21 of the in-vehicle device 2 continues the processing for waiting for a startup completion notification from the redundant ECU 32.

When the startup completion notification is received (step S106: YES), the control unit 21 of the in-vehicle device 2 outputs the received software and operation settings to the redundant ECU 32 (step S 107). When a startup completion notification is acquired (received) from the redundant ECU 32, the control unit 21 of the in-vehicle device 2 transmits (outputs), to the redundant ECU 32, the software acquired from the external server S1. Furthermore, the control unit 21 of the in-vehicle device 2 outputs, to the redundant ECU 32, the operation settings included in the state data acquired immediately before it is determined that the redundant ECU 32 is not operating normally (is abnormal). The redundant ECU 32 that has acquired (received) the software and the operation settings from the in-vehicle device 2 installs the software and executes the software by applying the operation settings. This makes it possible to continue (resume) the provision of the service or function by inheriting the operation settings of the in-vehicle ECU to be substituted for.

The control unit 21 of the in-vehicle device 2 changes the relay table in accordance with the specified redundant ECU 32 (step S 108). The control unit 21 of the in-vehicle device 2 updates the relay table by changing the relay destination of messages required to execute a service or function from the in-vehicle ECU 3 determined not to be operating normally (the in-vehicle ECU 3 to be substituted for) to the redundant ECU 32 that performs substitution processing for the in-vehicle ECU 3.

### Second Embodiment

FIG. 8 is a flowchart illustrating processing performed by the control unit 21 of the in-vehicle device 2 according to a second embodiment (specified based on the processing load). The control unit 21 of the in-vehicle device 2 performs the processing from step S201 to step S202 in the same manner as the processing from step S101 to step S102 in the first embodiment.

If any of the in-vehicle ECUs 3 is abnormal (step S202: YES), the control unit 21 of the in-vehicle device 2 determines whether or not there are a plurality of candidates that can become redundant ECUs 32 capable of substituting for the in-vehicle ECU 3 determined to be abnormal (step S203). For example, by referring to the substitution table, the control unit 21 of the in-vehicle device 2 specifies one or more redundant ECUs 32 that can substitute for the in-vehicle ECU 3 determined to be abnormal (the in-vehicle ECU 3 to be substituted for). If there is one redundant ECU 32 capable of substitution, it is determined that there are not a plurality of candidates, and if there are a plurality of redundant ECUs 32 capable of substitution, it is determined that there are a plurality of candidates. If there are not a plurality of candidates that can become the redundant ECU 32 (S203: NO), the control unit 21 of the in-vehicle device 2 specifies the redundant ECU 32 that is capable of substituting, in the same manner as in step S103 of the first embodiment (step S2031).

If there are a plurality of candidates that can become the redundant ECU 32 (step S 203: YES), the control unit 21 of the in-vehicle device 2 acquires the processing loads of the plurality of redundant ECUs 32 that are candidates (step S204). If there are a plurality of candidates that can become the redundant ECU 32, the control unit 21 of the in-vehicle device 2 acquires the processing load (CPU usage rate, memory usage rate) of each of the plurality of redundant ECUs 32 that are candidates, for example, by referring to an ECU state table. Since the ECU state table is updated based on the state data transmitted from each of the plurality of redundant ECUs 32, it is possible to acquire the processing load of each redundant ECU 32 at the time when the immediately preceding (most recent) state data was transmitted (time of transmission).

The control unit 21 of the in-vehicle device 2 specifies the redundant ECU 32 based on the processing load (step S205). Based on the acquired processing load, the control unit 21 of the in-vehicle device 2 specifies the redundant ECU 32 with the lowest processing load among the plurality of redundant ECUs 32 that are candidates as the redundant ECU 32 to substitute for the in-vehicle ECU 3 determined not to be operating normally.

During a period when the redundant ECU 32 is not executing substitution processing, the redundant ECU 32 may execute software corresponding to a newly added service in order to provide the service. In this case, it is assumed that the processing load (usage rate of hardware resources) will differ in the plurality of redundant ECUs 32 that are candidates, depending on the software being executed. In response to this, by specifying (selecting) the redundant ECU 32 with the lowest processing load from among the plurality of redundant ECUs 32 that are candidates, it is possible to balance the processing load among the plurality of redundant ECUs 32 that are candidates while ensuring the response and the like of substitution processing performed by the specified (selected) redundant ECU 32.

After executing step S205 or step S2031, the control unit 21 of the in-vehicle device 2 performs the processing of step S206. The control unit 21 of the in-vehicle device 2 performs the processing of steps S206 to S210 in the same manner as the processing of steps S104 to S108 in the first embodiment.

### Third Embodiment

FIG. 9 is a flowchart illustrating the processing performed by the control unit 21 of the in-vehicle device 2 according to a third embodiment (specifying based on the substitution capacity). The control unit 21 of the in-vehicle device 2 performs the processing from step S301 to step S302 in the same manner as the processing from step S101 to step S102 in the first embodiment. The control unit 21 of the in-vehicle device 2 performs the processing from step S303 to step S3031 in the same manner as the processing from step S203 to step S2031 in the second embodiment.

If there are a plurality of candidates that can become the redundant ECU 32 (step S 303: YES), the control unit 21 of the in-vehicle device 2 acquires the substitution capacities of the plurality of redundant ECUs 32 that are candidates (step S304). If there are a plurality of candidates that can become the redundant ECU 32, the control unit 21 of the in-vehicle device 2 acquires the substitution capacity for each of the plurality of candidate redundant ECUs 32, for example, by referring to a substitution table. The substitution capacity corresponds to the number of in-vehicle ECUs 3 that the redundant ECU 32 can substitute for, or the number of types of services, functions, and the like provided by the in-vehicle ECUs 3 that the redundant ECU 32 can substitute for.

A redundant ECU 32 with a relatively large substitution capacity has relatively high versatility, whereas a redundant ECU 32 with a relatively small substitution capacity has relatively low versatility. For example, in this embodiment, a redundant ECU 32 whose substitution capacity is one is a redundant ECU 32 that can perform substitution processing for only one specific in-vehicle ECU 3, such as one of the backup ECUs 31.

The control unit 21 of the in-vehicle device 2 specifies the redundant ECU 32 based on the substitution capacity (step S305). Based on the substitution capacity, the control unit 21 of the in-vehicle device 2 specifies, for example, the redundant ECU 32 with the smallest substitution capacity as the redundant ECU 32 to substitute for the in-vehicle ECU 3 determined not to be operating normally. Among the plurality of redundant ECUs 32 that are candidates, for example, a redundant ECU 32 with a substitution capacity of one, that is, a redundant ECU 32 that can substitute for only the in-vehicle ECU 3 determined not to be operating normally (the in-vehicle ECU 3 to be substituted for), is specified (selected).

Furthermore, if there are a plurality of redundant ECUs 32 with the smallest substitution capacity (for example, redundant ECUs 32 with a substitution capacity of one), the redundant ECU 32 with the lowest processing load may be specified (selected) from among these redundant ECUs 32, as in the second embodiment. In this manner, if there are a plurality of redundant ECUs 32 that are candidates, in addition to the substitution capacities (determined with priority based on the substitution capacity), it is also possible to specify (select) one of the redundant ECUs 32 with the lowest processing load. That is, if there are a plurality of redundant ECUs 32 that are candidates, the control unit 21 of the in-vehicle device 2 may specify (select) one of the redundant ECUs 32 by combining the substitution capacity and the processing load. This allows the redundant ECUs 32 to be specified in a well-balanced manner, thereby improving the availability of the in-vehicle system S including the redundant ECUs 32.

After executing step S305 or step S3031, the control unit 21 of the in-vehicle device 2 performs the processing of step S306. The control unit 21 of the in-vehicle device 2 performs the processing from step S306 to step S310 in the same manner as the processing from step S104 to step S108 in the first embodiment.

### Fourth Embodiment

FIG. 10 is a schematic diagram illustrating a system configuration of an in-vehicle system S according to a fourth embodiment (an integrated ECU including a redundant ECU 32). The in-vehicle system S in this embodiment includes an in-vehicle device 2 (integrated ECU), and a plurality of in-vehicle ECUs 3 such as backup ECUs 31 and redundant ECUs 32, similarly to the first embodiment.

The control unit 21 of the in-vehicle device 2 functions as the redundant ECU 32 by executing software that is the same as or compatible with the in-vehicle ECU 3 to be substituted for, similarly to the redundant ECU 32 of the first embodiment. That is, the in-vehicle device 2 includes the redundant ECU 32. By using the in-vehicle device 2 configured in this manner, even if the processing load of another redundant ECU 32 connected to the in-vehicle network 4 exceeds an allowable value, the in-vehicle device 2 functioning as the redundant ECU 32 can perform substitution processing for any of the in-vehicle ECUs 3.

Alternatively, the redundant ECU 32 installed in the vehicle C may be only the redundant ECU 32 implemented (included) in the in-vehicle device 2, and the need for each redundant ECU 32 connected to the in-vehicle network 4 may be eliminated. In this case, the CPU or memory of the in-vehicle device 2 may be implemented with additional hardware resources than those assumed when the in-vehicle device 2 functions as an integrated ECU, for example. In this manner, the in-vehicle device 2 essentially includes the redundant ECU 32, whereby surplus resources of the in-vehicle device 2, such as free time in the control unit 21 of the in-vehicle device 2, can be allocated to processing as the redundant ECU 32.

### Supplementary Note

An in-vehicle system S including:
an in-vehicle device 2 that is mounted in a vehicle C and is communicably connected to a plurality of in-vehicle ECUs 3; and
a redundant ECU 32 configured to substitute for any one of the in-vehicle ECUs 3,
in which the in-vehicle device 2 acquires state data related to states of the in-vehicle ECUs 3 from the in-vehicle ECUs 3,
if it is determined that an in-vehicle ECU 3 of the in-vehicle ECUs 3 is not operating normally based on the acquired state data, the in-vehicle device 2 specifies the redundant ECU 32 to substitute for the in-vehicle ECU 3 determined not to be operating normally,
the in-vehicle device 2 performs processing for causing the redundant ECU 32 to substitute for the in-vehicle ECU 3 determined not to be operating normally, and
in response to an instruction from the in-vehicle device 2, the redundant ECU 32 starts processing for substituting for the in-vehicle ECU 3 determined not to be operating normally.

The embodiments disclosed herein are to be considered in all respects as illustrative and not restrictive. The scope of the present disclosure is defined not by the above meaning but by the claims, and is intended to encompass all modifications within the meaning and scope equivalent to the claims.

The claims set forth in the claims can be combined with each other, regardless of the citation format. In the claims, a multiple dependent claim that is dependent on a plurality of claims may be described. A multiple dependent claim that is dependent on a multiple dependent claim may also be described. Even if no multiple dependent claim that is dependent on a multiple dependent claim is described, this does not preclude the inclusion of such a claim.

1. An in-vehicle device that is mounted in a vehicle and is communicably connected to a plurality of in-vehicle ECUs, comprising
a control unit configured to perform processing related to state management of the in-vehicle ECUs,
wherein the control unit acquires state data related to states of the in-vehicle ECUs from the in-vehicle ECUs,
if it is determined based on the acquired state data that an in-vehicle ECU of the in-vehicle ECUs is not operating normally, the control unit specifies a redundant ECU to substitute for the in-vehicle ECU determined not to be operating normally,
the control unit performs processing for causing the redundant ECU to substitute for the in-vehicle ECU determined not to be operating normally,
if there are a plurality of candidates for the redundant ECU to substitute for the in-vehicle ECU determined not to be operating normally, the control unit specifies one of the redundant ECUs based on substitution capacities of the plurality of redundant ECUs that are candidates,
each of the substitution capacities corresponds to the number of the in-vehicle ECUs that can be substituted for by the corresponding redundant ECU, or the number of types of services or functions provided by the in-vehicle ECU that can be substituted for by the corresponding redundant ECU, and
the control unit specifies a redundant ECU with the lowest substitution capacity among the plurality of redundant ECUs that are candidates.

2. The in-vehicle device according to claim 1,
wherein the control unit acquires software to be executed by the in-vehicle ECU determined not to be operating normally, and
the control unit performs processing for causing the redundant ECU to perform substitution by outputting the acquired software to the redundant ECU.

3. The in-vehicle device according to claim 2,
wherein the state data acquired from the in-vehicle ECU includes setting information related to an operation setting of the in-vehicle ECU at the time of transmitting the state data, and
the control unit performs the processing for causing the redundant ECU to perform substitution by outputting the setting information to the redundant ECU.

4. The in-vehicle device according to claim 1,
wherein the control unit uses a relay table stored in an accessible storage region to perform processing for relaying messages transmitted and received between a plurality of the in-vehicle ECUs, and
the control unit changes the relay table according to the specified redundant ECU.

5. The in-vehicle device according to claim 1,
wherein a substitution table related to substitution performed by each of a plurality of the redundant ECUs is stored in a storage region that is accessible by the control unit, and
the control unit specifies one of the plurality of redundant ECUs by referring to the substitution table.

6. The in-vehicle device according to claim 5,
wherein the redundant ECU is configured to be additionally attached after production of the vehicle,
when the redundant ECU is attached to the vehicle, the redundant ECU outputs substitution information related to substitution performed by the redundant ECU, and
the control unit changes the substitution table according to the substitution information acquired from the redundant ECU.

7. The in-vehicle device according to claim 1, wherein if there are a plurality of candidates for the redundant ECU to substitute for the in-vehicle ECU determined not to be operating normally, the control unit specifies one of the redundant ECUs based on current processing loads of the plurality of redundant ECUs that are candidates.

8. (canceled)

9. The in-vehicle device according to claim 1, wherein the control unit functions as the redundant ECU.

10. A program for causing a computer that is communicably connected to a plurality of in-vehicle ECUs to execute processing for:
acquiring state data related to states of the in-vehicle ECUs from the in-vehicle ECUs;
specifying, if it is determined based on the acquired state data that an in-vehicle ECU of the in-vehicle ECUs is not operating normally, a redundant ECU to substitute for the in-vehicle ECU determined not to be operating normally; and
causing the redundant ECU to substitute for the in-vehicle ECU determined not to be operating normally;
specifying, if there are a plurality of candidates for the redundant ECU to substitute for the in-vehicle ECU determined not to be operating normally, one of the redundant ECUs based on substitution capacities of the plurality of redundant ECUs that are candidates,
wherein each of the substitution capacities corresponds to the number of the in-vehicle ECUs that can be substituted for by the corresponding redundant ECU, or the number of types of services or functions provided by the in-vehicle ECU that can be substituted for by the corresponding redundant ECU,
the program further causing the computer to execute processing for specifying a redundant ECU with the lowest substitution capacity among the plurality of redundant ECUs that are candidates.

11. An information processing method for causing a computer that is communicably connected to a plurality of in-vehicle ECUs to execute processing for:
acquiring state data related to states of the in-vehicle ECUs from the in-vehicle ECUs;
specifying, if it is determined based on the acquired state data that an in-vehicle ECU of the in-vehicle ECUs is not operating normally, a redundant ECU to substitute for the in-vehicle ECU determined not to be operating normally;
causing the redundant ECU to substitute for the in-vehicle ECU determined not to be operating normally;
specifying, if there are a plurality of candidates for the redundant ECU to substitute for the in-vehicle ECU determined not to be operating normally, one of the redundant ECUs based on substitution capacities of the plurality of redundant ECUs that are candidates.
wherein each of the substitution capacities corresponds to the number of the in-vehicle ECUs that can be substituted for by the corresponding redundant ECU, or the number of types of services or functions provided by the in-vehicle ECU that can be substituted for by the corresponding redundant ECU,
the information processing method further causing the computer to execute processing for specifying a redundant ECU with the lowest substitution capacity among the plurality of redundant ECUs that are candidates.
